(19) United States
(12) Patent Application Publication
(10) Pub. No.: US 2021/0247414 A1
(43) Pub. Date: Aug. 12, 2021

(54) ROTATION DETECTION DEVICE AND METHOD FOR DETECTING ROTATION

(71) Applicant: MITSUBISHI HEAVY INDUSTRIES, LTD., Tokyo (JP)

(72) Inventors: Yuichiro SAWADA, Tokyo (JP); Hideki TONAKA, Tokyo (JP); Yusuke YAMASHINA, Tokyo (JP)

(21) Appl. No.: 17/155,227

(22) Filed: Jan. 22, 2021

(30) Foreign Application Priority Data
Feb. 10, 2020 (JP) 2020-020483

(51) Int. Cl. G01P 3/02

(52) U.S. Cl. CPC G01P 3/02

(57) ABSTRACT

A rotation detection device to solve the above-described problems includes: accelerometers installed to be spaced apart from each other at predetermined pitches around a rotating shaft of a rotary machine, the accelerometers detecting rotation vibration of the rotary machine and outputting vibration signals; and a signal processing unit that acquires the vibration signals from the accelerometers. The signal processing unit includes: an installation information acquisition means for acquiring installation radii of the accelerometers with respect to the rotating shaft; an analysis processing means for acquiring frequency responses and coherences for the vibration signals; a determination means for determining whether or not the coherences are greater than a predetermined threshold value; and a rotation period calculation means for calculating a rotation period of the rotating shaft from the frequency, the phase difference, the predetermined pitch, and the installation radii.

### CROSS-REFERENCE TO RELATED APPLICATIONS

This application claims the benefit of priority to Japanese Patent Application Number 2020-020483 filed on Feb. 10, 2020. The entire contents of the above-identified application are hereby incorporated by reference.

### TECHNICAL FIELD

The disclosure relates to a rotation detection device and a method for detecting rotation.

### RELATED ART

The vibration analysis of a rotary machine is typically performed based on a rotation period of the rotary machine.

JP 2017-044572 A describes an invention in which a rotor is monitored by attaching a plurality of non-contact displacement sensors to a bearing portion of the rotor with an angular difference and by detecting displacement and the rotational speed of the rotor.

### SUMMARY

Some rotary machines operating in a plant or the like are not provided with a rotation meter that detects the rotational speed of the rotating body. Furthermore, some rotary machines have a structure in which a rotating body cannot be monitored from the outside. If minor vibration occurs in a rotary machine in operation, it is not practical to stop the rotary machine only for installing a rotation meter, so the rotation period of the rotary machine may be unknown, and it may take time to investigate the cause.

The disclosure has been made in view of such problems, and an object of the disclosure is to provide a rotation detection device that can be installed even to a rotary machine in operation without stopping the operation of the rotary machine; and a method for detecting rotation.

A rotation detection device to solve the above-described problems includes: two or more accelerometers installed at predetermined pitches around a rotating shaft of a rotary machine, the two or more accelerometers detecting rotation vibration of the rotary machine and outputting vibration signals; and

a signal processing unit that acquires the vibration signals from the two or more accelerometers. The signal processing unit includes: an installation information acquisition means for acquiring installation radii of the two or more accelerometers with respect to the rotating shaft; an analysis processing means for acquiring frequency responses and coherences for the vibration signals; a determination means for determining whether or not the coherences are greater than a predetermined threshold value; and a rotation period calculation means for acquiring a frequency of and a phase difference of the vibration signals for the coherences, when determined to be greater than the threshold value, and calculating a rotation period of the rotating shaft from the frequency, the phase difference, the predetermined pitches, and the installation radii.

A method for detecting rotation to solve the above-described problems includes: a step of installing accelerometers which detect rotation vibration of a rotary machine and output vibration signals, at predetermined pitches around a rotating shaft of the rotary machine; a step of acquiring the vibration signals from the accelerometers; a step of acquiring installation radii around the rotating shaft of the accelerometers; a step of performing coherence analysis on the vibration signals to acquire coherences per frequency band; a step of determining whether or not the coherences are greater than a predetermined threshold value; a step of performing frequency response analysis on the vibration signals to acquire frequency responses; a step of acquiring a frequency of the vibration signals; a step of acquiring a phase difference of the vibration signals; and a step of acquiring a rotation period of the rotating shaft, based on the frequency, the phase difference, the installation radii, and the predetermined pitches.

According to the present disclosure, the rotation detection device enables installation of an acceleration detection unit even to a rotary machine in operation without stopping the operation of the rotary machine. This allows the rotation period of the rotary machine to be acquired from the vibration signals acquired by the acceleration detection unit. In addition, the rotation reference signal corresponding to the acquired rotation period is output, thereby making it possible to perform vibration analysis of the rotary machine based on the rotation period.

### BRIEF DESCRIPTION OF DRAWINGS

The disclosure will be described with reference to the accompanying drawings, wherein like numbers reference like elements.

FIG. 1 is a block diagram of a rotation detection device according to the present embodiment.

FIG. 2 is a general perspective view of the rotation detection device according to the present embodiment.

FIG. 3 is a view of an acceleration detection unit according to the present embodiment, which is installed on a rotary machine.

FIG. 4 is a flowchart of a method for detecting rotation according to the present embodiment.

FIG. 5 is a view illustrating coherences of vibration signals according to the present embodiment.

FIG. 6 is a view illustrating frequency responses of the vibration signals according to the present embodiment.

FIG. 7 is a view illustrating signals output from the rotation detection device according to the present embodiment.

### DESCRIPTION OF EMBODIMENTS

Below, embodiments of the present disclosure will be described in detail with reference to the drawings. Hereinafter, accelerometers Ma, Mb, and Mc are referred to as accelerometers M, unless specifically mentioned individually. In addition, vibration signals S_{V}a, S_{V}b, and S_{V}c are referred to as vibration signals S_{V}, unless specifically mentioned individually. Furthermore, gravity signals S_{G}a, S_{G}b, and S_{G}c are referred to as gravity signals S_{G}, unless specifically mentioned individually.

### Rotation Detection Device

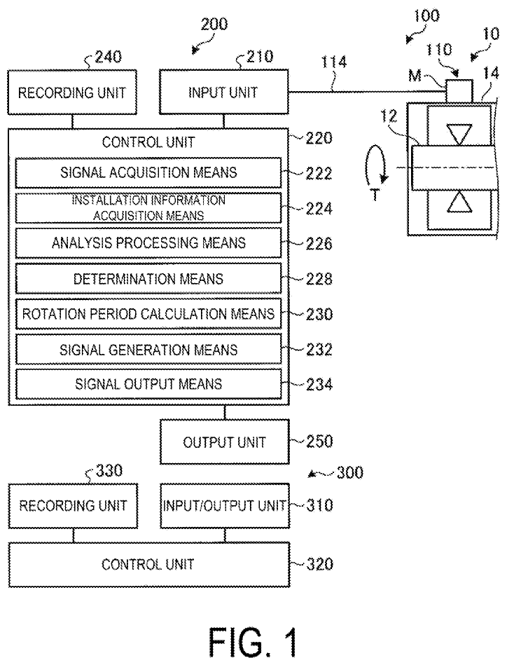

A rotation detection device 100 according to a working example of the present disclosure will be described below with reference to FIG. 1. The rotation detection device 100 detects a rotation period T by vibration signals S_{V} based on rotation vibration of a rotating shaft 12 of a rotary machine 10. The rotation detection device 100 includes an acceleration detection unit 110 and a signal processing unit 200.

### Acceleration Detection Unit

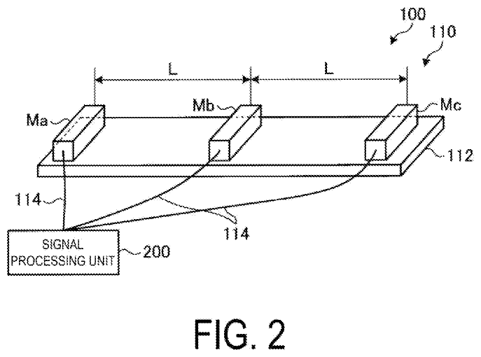

The acceleration detection unit 110 is configured by arranging three accelerometers Ma, Mb, and Mc on a sheet 112 at predetermined pitches L. The three accelerometers Ma, Mb, and Mc are each installed with a separation angle of less than 180° around the rotating shaft 12 of the rotary machine 10. The three accelerometers Ma, Mb, and Mc are arranged serially in a circumferential direction of the rotating shaft 12, and each of the pitches L is retained by the sheet (interval holding member) 112. A general perspective view of the rotation detection device 100 is shown in FIG. 2. Three accelerometers Ma, Mb, and Mc are arranged on the sheet 112, and each of the pitches between the accelerometers Ma and Mb and between the accelerometers Mb and Mc is L. Thus, the three accelerometers Ma, Mb, and Mc are installed with equal pitches L around the rotating shaft 12. The pitch between the accelerometers Ma and Mb and the pitch between the accelerometers Mb and Mc may be different from each other. The three accelerometers Ma, Mb, and Mc may each be configured to be repositionable from the sheet 112.

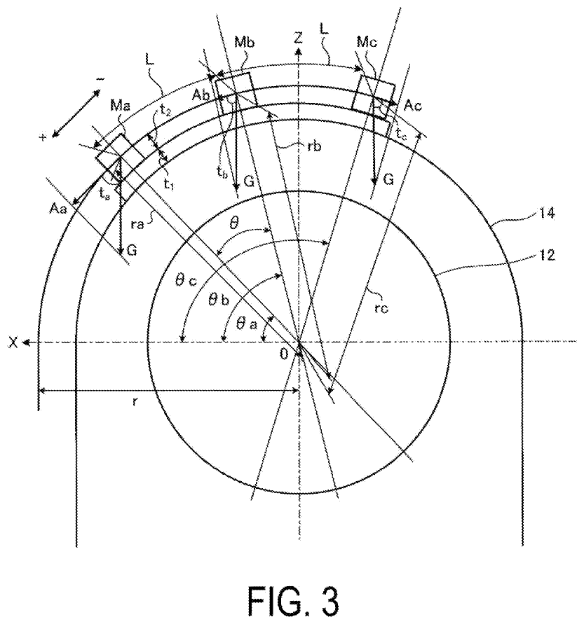

The acceleration detection unit 110 is installed around the rotating shaft 12 on a bearing portion 14 in a housing of the rotary machine 10. That is, the three accelerometers M are installed at different angles around the rotating shaft 12 of the rotary machine 10, respectively. In FIG. 3, the three accelerometers Ma, Mb, and Mc are installed on the bearing portion 14 of the rotary machine 10, with angles θa, θb, and θc, respectively, around the rotating shaft 12 with respect to the horizontal axis. None of the separation angles [θb-θa], [θc-θb] and [θc-θa] is 180°. The separation angles [θbθa] and [θc-θb] may be the same.

### Accelerometer

The accelerometers Ma, Mb, and Mc detect the rotation vibration of the rotary machine 10 and AC (AC voltage)-output the vibration signals S_{V}a, S_{V}b, and S_{V}c, respectively. Additionally, the accelerometers Ma, Mb, and Mc detect gravity acceleration and DC (DC voltage)-output the gravity signals S_{G}a, S_{G}b, and S_{G}c, respectively.

The detection method of the accelerometers M may be any detection method and preferably capable of: detecting the rotation vibration of the rotary machine 10, detecting the vibration signals S_{V} and the gravity acceleration, and outputting the gravity signals S_{G}.

The sheet 112 defines the positions of the accelerometers M so that the accelerometers M are arranged at the predetermined pitches L. The sheet 112 is formed of a thin film having a thickness t1. The sheet 112 is formed of a flexible, non-stretchable material. Here, the term “thin” means that the difference between: the pitch, when arranged on concentric circles of the rotating shaft 12 of the bearing portion 14, between the detection units of the accelerometers M on the concentric circles of the rotating shaft; and the pitch L, in a state of being placed on a plane, between the detection units of the accelerometers M arranged on the sheet 112 is negligible in calculating the rotation period T. Here, the term “non-stretchable” means that the difference between: the pitch, when arranged on concentric circles of the rotating shaft 12 of the bearing portion 14, between the detection units of the accelerometers M on the concentric circles of the rotating shaft; and the pitch L, in a state of being placed on a plane, between the detection units of the accelerometers M arranged on the sheet 112 is negligible in calculating the rotation period T. Additionally, the term “flexible” means that the material is flexible at such a level that, when the acceleration detection unit 110 is arranged on the bearing portion 14 in the housing of the rotary machine 10, the sheet 112 conforms to the shape of the bearing portion 14 and thus that the difference between: each installation radius r of the detection units of the accelerometers M arranged on the sheet 112; and a length obtained by adding, to the radius of the bearing portion 14, the thickness t1 of the sheet 112 and a height t2 from a mounting surface of the sheet 112 to the detection units of the accelerometers M is negligible in calculating the rotation period T (FIG. 3).

### Signal Processing Unit

The signal processing unit 200 calculates and acquires the rotation period T of the rotary machine 10, based on the vibration signals S_{V} output from the accelerometers M. The signal processing unit 200 calculates and acquires the installation radii r and installation angles θ of the accelerometers M, based on the gravity signals S_{G} output from the accelerometers M. The signal processing unit 200 includes an input unit 210, a control unit 220, a recording unit 240, and an output unit 250. The input unit 210, the recording unit 240, and the output unit 250 are each connected to the control unit 220.

### Input Unit

The input unit 210 acquires the vibration signals S_{V} and gravity signals S_{G} output from the accelerometers M and sends the signals to the control unit 220. The input unit 210 is electrically connected to the accelerometers M by cables 114. The input unit 210 may he connected to the accelerometers M via wireless communication. The input unit 210 may be configured to acquire the vibration signals S_{V} and gravity signals S_{G} from the accelerometers M via a portable recording medium. The input unit 210 may be provided with an external input device such as a keyboard, a mouse, or the like, which is not illustrated.

### Control Unit

The control unit 220 performs predetermined processing on the vibration signals S_{V} and gravity signals S_{G} sent from the input unit 210. As illustrated in FIG. 1, the control unit 220 includes: a signal acquisition means 222, an installation information acquisition means 224, an analysis processing means 226, a determination means 228, a rotation period calculation means 230, a signal generation means 232, and a signal output means 234. Each of the means is developed by executing a program recorded in the recording unit 240 by the control unit 220. The control unit 220 is configured by a CPU (central processing unit).

### Signal Acquisition Means

The control unit 220 acquires, by the signal acquisition means 222, the vibration signals S_{V} and gravity signals S_{G} output by the accelerometers M. The vibration signals S_{V} and the gravity signals S_{G} are amplitude data on voltage values per time series acquired at a predetermined sampling period by the accelerometers M. The “predetermined sampling period” is a period in which the accelerometers M acquire the vibration signals S_{V} and the gravity signals S_{G}. The predetermined sampling period is set based, for example, on the rated rotational speed of the rotary machine 10, the response time of the accelerometers M, and the installation radii R thereof. The control unit 220 records, in the recording unit 240, the acquired vibration signals S_{V} and gravity signals S_{G} and data based on the acquired signals.

### Installation Information Acquisition Means

The control unit 220 calculates and acquires the installation angles θ1, θ2, and θ3 and installation radii ra, rb, and rc, around the rotating shaft 12, of the accelerometers Ma, Mb, and Mc, based on the acquired gravity signals S_{G}a, S_{G}b, and S_{G}c by the installation information acquisition means 224. Note that given values may be acquired as the installation angles θ and installation radii r of the accelerometers Ma, Mb, and Mc.

### Analysis Processing Means

The control unit 220 performs coherence analysis on frequency functions Fa, Fb, and Fc of the vibration signals S_{V}a, S_{V}b, and S_{V}c to acquire coherences C by the analysis processing means 226. The coherences C are determined by a correlation function between the frequency function Fa and the frequency function Fb, and a correlation function between the frequency function Fb and the frequency function Fc. The coherences C are given as numerical values ranging from 0 to 1. The coherence C nearer to 1 indicates higher correlation in a predetermined frequency band between the two frequency functions. The control unit 220 may acquire a frequency f1 for the high coherences C.

Furthermore, the control unit 220 acquires, by the analysis processing means 226, a phase difference p1 among the vibration signal S_{V}a, S_{V}b, and S_{V}c. Specifically, the control unit 220 acquires: a frequency response FRFa of the frequency function Fb to the frequency function Fa; and a frequency response FRFb of the frequency function Fc to the frequency function Fb, performs frequency response analysis on the acquired frequency response FRFa and frequency response FRFb, and thus acquires the phase difference p1.

### Determination Means

The control unit 220 determines, by the determination means 228, whether or not the coherences C are greater than a predetermined threshold value. The predetermined threshold value is a set value. The predetermined threshold value may be preset. The predetermined threshold value can be determined by taking into consideration of: the magnitude of the vibration signals S_{V} acquired from the rotary machine 10, the magnitude of a noise signal generated by any other noise of the rotary machine 10, and the like.

### Rotation Period Calculation Means

The control unit 220 acquires, by the rotation period calculation means 230, the rotation period T of the rotating shaft 12 from the acquired frequency f, a phase difference p, the pitch L, and the installation radii r. Specifically, after calculating and acquiring a delay time D from the acquired frequency f and the phase difference p, the control unit 220 calculates and acquires the rotation period T from the delay time D, the pitches L, and the installation radii r.

### Signal Generation Means

The control unit 220 generates a rotation reference signal S_{T} for the rotation period T by the signal generation means 232. The rotation reference signal S_{T} is a voltage output per time period and indicates a predetermined voltage value per rotation period T. The rotation reference signal S_{T} is, for example, a square wave.

### Signal Output Means

The control unit 220 outputs the rotation reference signal S_{T} from the output unit 250, which will be described later, by the signal output means 234. The rotation reference signal S_{T} is, for example, a voltage output per time period and indicates a predetermined voltage value per rotation period T. The signal output means 234 can output the vibration signals S_{V} together with the rotation reference signal S_{T}. Furthermore, the signal output means 234 can process the vibration signals S_{V} and the rotation reference signal S_{T} into data divided per rotation period T and can output the data.

### Recording Unit

The recording unit 240 records the data created by: the gravity signals S_{G} and vibration signals S_{V} acquired by the control unit 220, the rotation reference signal S_{T} generated thereby, and the data created in the each of the means of the control unit 220. The recording unit 240 is constituted of, for example, an HDD (hard disk drive).

### Output Unit

The output unit 250 outputs, to the outside, the rotation reference signal S_{T}, the gravity signals S_{G}, the vibration signals S_{V}, and/or the data recorded in the recording unit 240. The output unit 250 is connected to the outside via a network and can transmit data. The output unit 250 can output data to a portable recording medium and record the data therein. The output unit 250 may include a display monitor that displays the generated rotation reference signal S_{T}, the acquired gravity signals S_{G} and vibration signals S_{V}, and/or the data processed based on these signals.

### Remote Processing Unit

A remote processing unit 300 acquires and processes the data output from the output unit 250 of the rotation detection device 100 at a location remote from the rotation detection device 100. The remote processing unit 300 includes an input/output unit 310, a control unit 320, and a recording unit 330. The remote processing unit 300 can acquire data from the rotation detection device 100. The input/output unit 310 includes a display monitor, a keyboard, a mouse, and the like, which are not illustrated. The remote processing unit 300 may include a program included in the recording unit 240 of the rotation detection device 100 in the recording unit 330, and the control unit 320 may be configured to be able to develop the respective means of the control unit 220. The remote processing unit 300 may be a PC (personal computer).

The input/output unit 310 of the remote processing unit 300 is connected to the rotation detection device 100 via a network. The remote processing unit 300 may be able to acquire the data acquired by the rotation detection device 100 in real time from the signal processing unit 200 via the input/output unit 310. The remote processing unit 300 may acquire the data acquired by the rotation detection device 100 by a portable recording medium.

### Method for Detecting Rotation

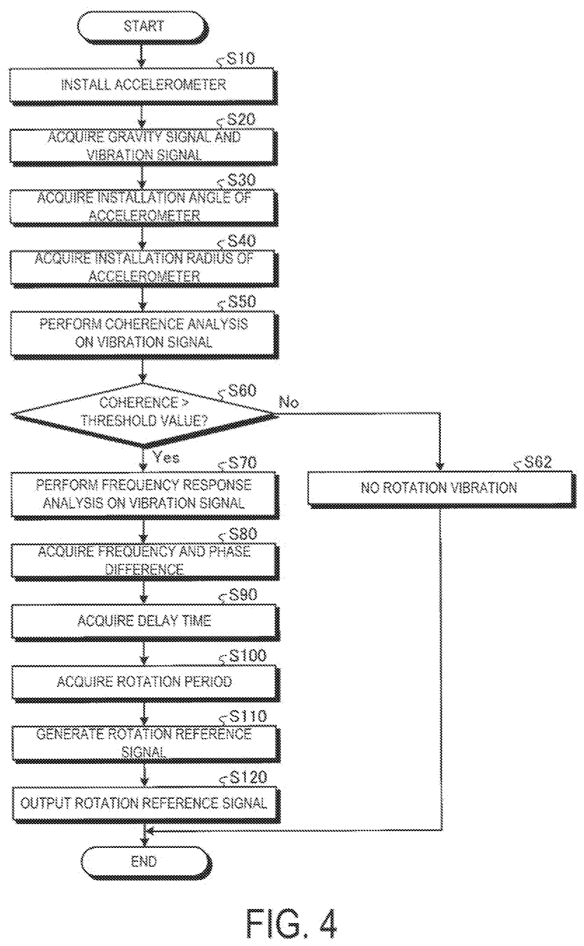

Hereinafter, the method for detecting rotation will be described below with reference to FIGS. 3 and 4. in the following description, a case in which the three accelerometers Ma, Mb, and Mc are used will be described. The acceleration detection unit 110 constituting the rotation detection device 100 is installed around the rotating shaft 12 of the bearing portion 14 of the rotary machine 10 in operation. Here, the accelerometers Ma, Mb, and Mc arranged in the acceleration detection unit 110 are installed so as to have different installation angles θa, θb, and θc, respectively, with respect to the X axis, around the rotating shall 12 of the bearing portion 14 (S10 in FIG. 4).

The rotation detection device 100 acquires, by the signal acquisition means 222, the vibration signals S_{V}a, S_{V}b, and S_{V}c and gravity signals S_{G}a, S_{G}b, and S_{G}c detected by the accelerometers Ma, Mb, and Mc installed in the rotary machine 10 (S20).

The rotation detection device 100 acquires the installation angles θa, θb, and θc of the accelerometers Ma, Mb, and Mc from the gravity signals S_{G}a, S_{G}b, and S_{G}c by the installation information acquisition means 224 (S30).

Hereinafter, a calculation method in a case where the rotation detection device 100 calculates and acquires the installation angles θa, θb, and θc from the gravity signals S_{G}a, S_{G}b, and S_{G}c will be described. FIG. 3 is a view in which the acceleration detection unit 110 is installed on a housing of the bearing portion 14 of the rotary machine 10. The acceleration detection unit 110 is installed on a bearing portion 14 formed concentrically with the rotating shaft 12 in the housing of the rotary machine 10. The concentric circle in which the acceleration detection unit 110 is installed has the radius r. The radius r of the concentric circle is a length obtained by adding, to the radius of the housing of the bearing portion 14, the thickness t1 of the sheet 112 and the height t2 from a mounting surface of the accelerometers M to their acceleration detection portions. The accelerometers Ma, Mb, and Mc are installed at different angles θa, θb, and θc, respectively, with respect to the X axis. The rotating shaft 12 rotates to the right in the orientation illustrated in FIG. 3.

Acceleration components in a tangential direction on the concentric circles of the rotating shaft 12, of gravity acceleration G received by the accelerometers Ma, Mb, and Mc arranged on the concentric circles of the rotating shaft 12 are designated as Aa, Ab, and Ac, respectively. When the angles of the acceleration components Aa, Ab, and Ac with respect to the vertical direction are ta, tb, and tc, respectively, the angles ta, tb, and tc are expressed by the following Equations 1 to 3.

ta=COS⁻¹(Aa/G) . . . (Equation 1)

tb=COS⁻¹(Ab/G) . . . (Equation 2)

tc=COS⁻¹(Ac/G) . . . (Equation 3)

Here, when the phase difference p in the frequency response which will be described below is positive, θa=ta, θb=tb, and θc=tc, and when the phase difference p is negative, θa=180−ta, θb=180−tb, and θc=180−tc. The rotation detection device 100 thus calculates and acquires the installation angles θa, θb, and θc of the accelerometers Ma, Mb, and Mc from the gravity signals S_{G}a, S_{G}b, and S_{G}c.

The rotation detection device 100 calculates and acquires, by the installation information acquisition means 224, the installation radii ra, rb, and rc of the accelerometers Ma. Mb, and Mc installed in the bearing portion 14 from the gravity signals S_{G}a, S_{G}b, and S_{G}c, respectively (S40). Hereinafter, a method for calculating the installation radii will be described. The accelerometers Ma, Mb, and Mc are arranged on the sheet 112 at the predetermined pitches L, as illustrated in FIG. 2, and thus have arc lengths L which are identical as the pitches L even when the acceleration detection unit 110 is installed on a concentric circle of the bearing portion 14 (FIG. 3). The respective installation radii ra, rb, and cc of the accelerometers Ma, Mb, and Mc are expressed by the following Equations 4 to 6.

ra=180/(π×(θb−θa))×L . . . (Equation 4)

rb=180/(π×(θc−θb))×L . . . (Equation 5)

rc=180/(π×(θc−θa))×2×L . . . (Equation 6)

The rotation detection device 100 thus calculates and acquires the installation radii ra, rb, and rc of the accelerometers Ma, Mb, and Mc from the gravity signals S_{G}. The installation radius r is acquired based on the installation radii ra, rb, and rc. The installation radius r is, for example, an average value of the installation radii ra, rb, and rc.

The separation angles [θb−θa] and [θc−θb] of the accelerometers Ma, Mb, and Mc are determined by the following Equations 7 to 9.

θb−θa=L/(π×r)×180 . . . (Equation 7)

θc−θb=L/(π×r)×180 . . . (Equation 8)

θc−θa=2×L/(π×r)×180 . . . (Equation 9)

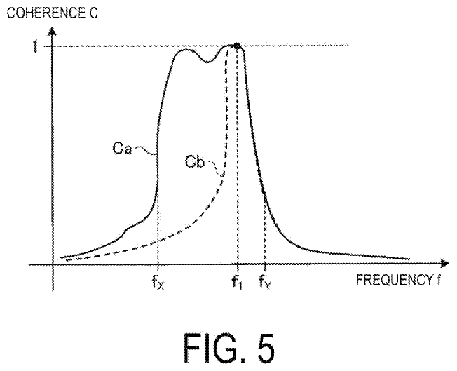

Hereinafter, the method for detecting rotation continues to be described. The rotation detection device 100 performs coherence analysis on the vibration signals S_{V} to acquire the coherences C by the analysis processing means 226 (S50). Specifically, by the analysis processing means 226, the rotation detection device 100 acquires: a correlation function for the frequency function Fb to the frequency function Fa; and a correlation function for the frequency function Fc to the frequency function Fb, from frequency functions for each vibration signal S_{V}, to determine the coherences C per predetermined frequency band for the respective correlation functions. In other words, the rotation detection device 100 acquires: a coherence Ca for the frequency function Fb to the frequency function Fa; and a coherence Cb per frequency band for the frequency function Fc to the frequency function Fb (FIG. 5).

As illustrated in FIG. 5, the rotation detection device 100 identifies and acquires a frequency band from a frequency fx to a frequency fy, showing high coherence values for the acquired coherences Ca and Cb, as a frequency band [fx-fy]. The frequency band [fx-fy] showing high coherence is a frequency band in which at least one of the coherences Ca and Cb indicates a value greater than the predetermined threshold value. Note that the frequency band [fx-fy] may be a frequency band in which the values of the coherence Ca and the coherence Cb are both greater than the predetermined threshold value. The predetermined threshold value for determining whether or not the coherences are high is, for example, 0.8. As illustrated in FIG. 5, the rotation detection device 100 may identify and acquire, as a frequency f1, the frequency in which the coherence Ca and the coherence Ch show the highest values in the frequency band [fx-fy].

The rotation detection device 100 determines, by the determination means 228, whether or not the coherences Ca and Cb in the acquired predetermined frequency band have the predetermined coherence (S60). If the rotation detection device 100 determines that the acquired coherences Ca and Cb values are greater than the predetermined threshold value, it determines the presence of coherence (Yes in S60), and the process proceeds to the next step. In a case where the acquired coherences Ca and Cb are determined to be less than or equal to the predetermined threshold value (No in S60), the rotation detection device 100 determines the absence of rotation vibration (S62). The threshold value for determining whether or not the acquired coherences Ca and Cb have the predetermined coherence is, for example, 0.8.

The rotation detection device 100 performs frequency response analysis on the vibration signals S_{V} by the analysis processing means 226 (S70). Specifically, the rotation detection device 100 acquires the frequency responses FRFa and FRFb to perform frequency response analysis on the frequency band [fx-fy], by the analysis processing means 226.

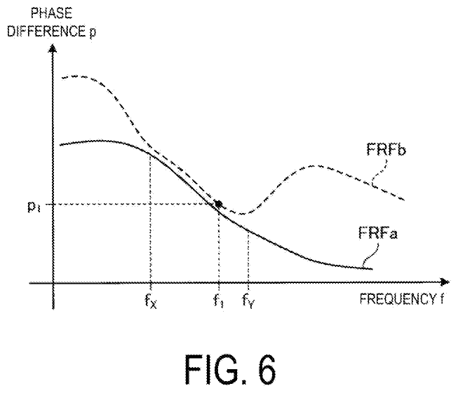

The rotation detection device 100 identifies and acquires the frequency f and the phase difference p from the frequency response analysis on the vibration signals S_{V} by the analysis processing means 226 (S80). Specifically, by the analysis processing means 226, the rotation detection device 100 acquires: a phase difference pa between the vibration signal S_{V}a and the vibration signal S_{V}b; and a phase difference pb between the vibration signal S_{V}b and the vibration signal S_{V}c, respectively, and, for phase difference pa and phase difference pb which are the acquired frequency responses, identifies and acquires the frequency, at which the difference between the phase difference pa and the phase difference pb is the lowest, as the frequency f1. Furthermore, the rotation detection device 100 identifies and acquires an average value of the phase difference pa and the phase difference pb at the acquired frequency f1 as the phase difference p1. In a case of the example illustrated in FIG. 6, the frequency f1 showing the highest coherence in FIG. 5; and the phase difference p1 at the frequency f1 are identified and acquired as the optimal frequency f and phase difference p.

The rotation detection device 100 calculates and acquires the delay time D from the frequency f and the phase difference p by the rotation period calculation means 230 (S90). The delay time D is determined by the following Equation 10:

D=1/f×p/360 . . . (Equation 10)

The rotation detection device 100 calculates and acquires the rotation period T from the delay time D, the installation radius r, and the predetermined pitch L by the rotation period calculation means 230 (S100). The rotation period T is determined by the following Equation 11:

T=(2×π×r/L)×D . . . (Equation 11)

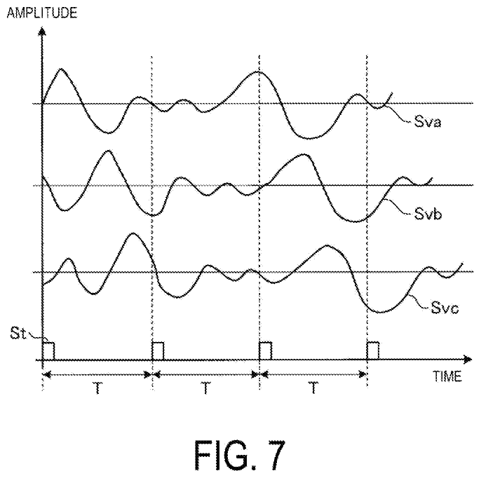

The rotation detection device 100 generates the rotation reference signal S_{T} corresponding to the rotation period T by the signal generation means 232 (S110). The rotation reference signal S_{T} is a square wave, for example, as illustrated in FIG. 7.

The rotation detection device 100 outputs the rotation reference signal S_{T} from the output unit 250 by the signal output means 234 (S120). The rotation reference signal S_{T} is output as a voltage output per time period.

The rotation detection device 100 may output the vibration signals S_{V} acquired from the accelerometers M along with the output of the rotation reference signal S_{T} by the signal output means 234. When the vibration signals S_{V} acquired from the accelerometers M are output along with the output of the rotation reference signal S_{T}, as illustrated in FIG. 7, the vibration signal S_{V}a, the vibration signal S_{V}b, and the vibration signal S_{V}c may each be output in correspondence with the time series of the rotation reference signal S_{T}. In this case, the rotation detection device 100 may divide and output the vibration signals S_{V} and the rotation reference signal S_{T} per period T.

### Method for Detecting Rotation Using Two Accelerometers

A method for detecting rotation by using the two accelerometers Ma and Mb will be described below. Note that the method for detecting rotation by using the two accelerometers Ma and Mb partially overlaps with the method for detecting rotation by using the three accelerometers described above, and therefore that a description is given to a process, from a step (S50) of performing coherence analysis on the vibration signals to acquire coherences to a step (S70) of performing frequency response analysis on the vibration signals to acquire frequency responses, which is a portion different from that in the case of using the three accelerometers described above.

The rotation detection device 100 performs coherence analysis on the vibration signals S_{V} to acquire the coherences C by the analysis processing means 226 (S50). Specifically, the coherences C are determined by the rotation detection device 100 using the analysis processing means 226 to determine: the frequency function Fa for the vibration signal S_{V}a from the accelerometer Ma; and the frequency function Fb for the vibration signal S_{V}b from the accelerometer Mb and to acquire a correlation function per frequency band for the frequency function Fb to the frequency function Fa.

By the analysis processing means 226, the rotation detection device 100 determines the coherences C from the determined correlation function and identifies and acquires a frequency band from the frequency fx to the frequency fy, showing high coherence values for the determined coherences C, as the frequency band [fx-fy]. The frequency band [fx-fy] may be a frequency band in which the coherences C are greater than the predetermined threshold value, in the frequency band. The predetermined threshold value for the acquired coherences C is, for example, 0.8.

The rotation detection device 100 determines, by the determination means 228, whether or not the acquired coherences C have predetermined coherence (S60). Specifically, when determined that the acquired coherences C are greater than the predetermined threshold value, the rotation detection device 100 determines the presence of coherence (Yes in S60), and the process proceeds to the next step. In a case where the rotation detection device 100 determines that the acquired coherences C are not greater than the predetermined threshold value (No in S60), it is processed as the absence of rotation vibration (S62). The threshold value for determining whether or not the acquired coherences C have the predetermined coherence is, for example, 0.8.

The rotation detection device 100 performs frequency response analysis on the vibration signals S_{V} by the analysis processing means 226 (S70). Specifically, the rotation detection device 100 acquires the frequency response FRFa and identifies and acquires the lowest phase difference p1 among the phase differences p between the vibration signal S_{V}a and the vibration signal S_{V}b in the frequency band [fx-fy], by frequency response analysis, for the frequency response FRFa. Furthermore, the rotation detection device 100 identifies and acquires the frequency f of the frequency response FRFa corresponding to the identified phase difference p1 as the frequency f1. Note that, as illustrated in FIG. 6, the rotation detection device 100 may identify and acquire a frequency at which the coherences C in the frequency hand [fx-fy] are closest to 1 as the frequency f1 and may acquire the phase difference at the frequency f1 as the phase difference p1.

### Other Embodiments

As illustrated in FIG. 1, the rotation detection device 100 can output the vibration signals S_{V} and the rotation reference signal S_{T} to the remote processing unit 300 by the signal output means 234. The data output from the output unit 250 of the rotation detection device 100 is acquired by the input/output unit 310 of the remote processing unit 300 and is recorded in the recording unit 330 via the control unit 320.

The data is passed from the rotation detection device 100 to the remote processing unit 300 via a wired or wireless network. Further, the data may be passed from the rotation detection device 100 to the remote processing unit 300 via a portable recording medium.

The data output from the rotation detection device 100 to the remote processing unit 300 includes at least one of the gravity signal S_{G}, the vibration signal S_{V} and the rotation reference signal S_{T}. The data output from the rotation detection device 100 to the remote processing unit 300 may be subjected to predetermined processing and output. For example, as illustrated in FIG. 7, the data output from the rotation detection device 100 to the remote processing unit 300 may be output while the vibration signals S_{V} are made to correspond to the time series of the rotation reference signal S_{T}. Furthermore, the rotation detection device 100 may divide and output the vibration signals S_{V} per rotation period T. The data passed from the rotation detection device 100 to the remote processing unit 300 is generated by the signal generation means 232.

### Description of Effect

The effects of each of aspects according to the present disclosure will be described below. The rotation detection device 100 according to a first aspect of the present disclosure includes: two or more accelerometers M installed at predetermined pitches L in a circumferential direction around a rotating shaft 12 of a rotary machine 10, the two or more accelerometers M detecting rotation vibration of the rotary machine 10 and outputting vibration signals S_{V}; and a signal processing unit 200 that acquires the vibration signals S_{V} from the two or more accelerometers M. The signal processing unit 200 includes: an installation information acquisition means 224 for acquiring installation radii r of the two or more accelerometers M with respect to the rotating shaft; an analysis processing means 226 for acquiring frequency responses FRFa and FRFb and coherences C for the vibration signals S_{V}; a determination means 228 for determining whether or not the coherences C are greater than a predetermined threshold value and a rotation period calculation means 230 for acquiring a frequency f1 and a phase difference p of the vibration signals S_{V} for the coherences C, when determined to be greater than the threshold value, and calculating a rotation period T of the rotating shaft 12 from the frequency f1, the phase difference p, the predetermined pitches L, and the installation radii r.

According to the first aspect, in the rotation detection device 100, the signal processing unit 200 includes: the installation information acquisition means 224, and thus it is possible to acquire the vibration signals S_{V} output from the two or more accelerometers M arranged spaced apart at the predetermined pitches L around the rotating shaft 12 of the rotary machine 10 and possible to acquire the installation radii r of the two or more accelerometers M with respect to the rotating shaft. In addition, since the signal processing unit 200 includes the analysis processing means 226, it is possible to acquire the frequency responses FRFa and FRFb and the coherences C for the vibration signals S_{V}, possible to determine, by the determination means 228, whether or not the coherences C are greater than a predetermined threshold value, and possible to acquire the frequency f1 and the phase difference p of the vibration signals S_{V} for the coherences C, when determined to be greater than the predetermined threshold value by the rotation period calculation means 230. In addition, since the signal processing unit 200 includes the rotation period calculation means 230, the rotation period T of the rotating shaft 12 can be calculated and acquired from the frequency f1, the phase difference p, the predetermined pitches L, and the installation radii r.

The rotation detection device 100 according to a second aspect of the present disclosure is configured, in the first aspect, such that the accelerometers M included in the rotation detection device 100 detect gravity acceleration G and output gravity signals S_{G}, such that the signal processing unit 200 acquires the gravity signals S_{G}, and such that the installation information acquisition means 224 acquires installation angles θ and the installation radii r of the accelerometers M around the rotating shaft 12, based on the gravity signals S _{G}.

According to the second aspect, the rotation detection device 100 includes the installation information acquisition means 224, and thus it is possible to acquire the installation angles θ and the installation radii r of the accelerometers M around the rotating shaft 12, based on the gravity signals S_{G} output from the two or more accelerometers M arranged spaced apart at the predetermined pitches L around the rotating shaft 12 of the rotary machine 10.

The rotation detection device 100 according to a third aspect of the present disclosure is configured, in the first aspect or the second aspect, such that the two or more accelerometers M are installed with a separation angle θ of less than 180° around the rotating shaft 12 of the rotary machine 10.

According to the third aspect, the two or more accelerometers M are installed with a separation angle θ of less than 180° around the rotating shaft 12 of the rotary machine 10, the signal processing unit 200 can acquire the vibration signals S_{V} having a phase difference of less than 180° from the two or more accelerometers M and can identify the rotational direction of the rotating shaft 12.

The rotation detection device 100 according to a fourth aspect of the present disclosure is configured, in any one of the first to third aspects, such that the two or more accelerometers M are arranged serially, and that each of the pitches L is retained by the interval holding member 112.

According to the fourth aspect, the two or more accelerometers M are arranged serially and each of the pitches L is retained by the interval holding member 112, and thus the rotation detection device 100 can retain the respective intervals between the two or more accelerometers M as the pitches L even in a state where the acceleration detection unit 110 is installed on the housing of the bearing portion 14.

The rotation detection device 100 according to a fifth aspect of the present disclosure is configured, in any one of the first to fourth aspects, such that the number of the accelerometers is three or more.

According to the fifth aspect, the rotation detection device 100 has three or more accelerometers, and thus it is possible to acquire three vibration signals S_{V} and gravity signals S_{G} and possible to accurately acquire the rotation period T based on the three or more vibration signals S_{V} and gravity signals S_{G}.

The rotation detection device 100 according to a sixth aspect of the present disclosure is configured, in any one of the first to fifth aspects, such that the three or more accelerometers M are installed with equal pitches L around the rotating shaft 12.

According to the sixth aspect, the three or more accelerometers M are installed with equal pitches L around the rotating shaft 12, and thus it is possible to accurately acquire the frequency f and the phase difference p, based on the three or more vibration signals S_{V}, and possible to calculate and acquire the rotation period T.

The rotation detection device 100 according to a seventh aspect of the present disclosure is configured, in any one of the first to sixth aspects, such that the signal processing unit 200 includes a signal generation means 232 that generates a rotation reference signal S_{T}, and the rotation reference signal S_{T} is generated in accordance with the rotation period T of the rotating shaft 12.

According to the seventh aspect, the rotation detection device 100 includes the signal generation means 232 in the signal processing unit 200, and thus it is possible to generate the rotation reference signal S_{T} in accordance with the rotation period T of the rotating shaft 12.

The rotation detection device according to an eighth aspect of the present disclosure is configured, in any one of the first to seventh aspects, such that the signal processing unit 200 includes an output unit 250 that outputs signals and/or data to the outside, and the rotation reference signal S_{T} is output from the output unit 250.

According to the eighth aspect, the rotation detection device 100 includes a signal output means 234 in the signal processing unit 200, and thus the rotation reference signal S_{T} corresponding to the rotation period T of the rotating shaft 12 can be generated.

The rotation detection device 100 according to a ninth aspect of the present disclosure is configured, in any one of the first to eighth aspects, such that the signal processing unit 200 outputs the rotation reference signal S_{T} from the output unit 250 per rotation period T of the rotating shaft 12.

According to the ninth aspect, the signal processing unit 200 outputs the rotation reference signal S_{T} from the output unit 250 per rotation period T of the rotating shaft 12, and thus the rotation reference signal S_{T} can be acquired in the outside.

The method for detecting rotation according to a tenth aspect of the present disclosure includes: a step of installing accelerometers M which detect rotation vibration of a rotary machine 10 and output vibration signals S_{V}, at predetermined pitches L around a rotating shaft 12 of the rotary machine 10 (S10); a step of acquiring the vibration signals S_{V} from the accelerometers M (S20); a step of acquiring installation radii r around the rotating shaft 12 of the accelerometers M (S30); a step of performing coherence analysis on the vibration signals S_{V} to acquire coherences C per frequency band (S40); a step of determining whether or not the coherences C are greater than a predetermined threshold value (S50); a step of performing frequency response analysis on the vibration signals S_{V} to acquire frequency responses (S60); a step of acquiring a frequency f1 of the vibration signals S_{V} (S70); a step of acquiring a phase difference of the vibration signals (S80); and a step of acquiring a rotation period of the rotating shaft, based on the frequency, the phase difference, the installation radius, and the predetermined pitches (S100).

According to the tenth aspect, effects equivalent to those according to the first aspect can be obtained by the method for detecting rotation according to the tenth aspect.

While preferred embodiments of the invention have been described as above, it is to be understood that variations and modifications will be apparent to those skilled in the art without departing from the scope and spirit of the invention. The scope of the invention, therefore, is to be determined solely by the following claims

1. A rotation detection device comprising:
two or more accelerometers installed at predetermined pitches in a circumferential direction around a rotating shaft of a rotary machine, the two or more accelerometers detecting rotation vibration of the rotary machine and outputting vibration signals; and
a signal processing unit that acquires the vibration signals from the two or more accelerometers,
wherein the signal processing unit comprises:
an installation information acquisition means for acquiring installation radii of the two or more accelerometers with respect to the rotating shaft;
an analysis processing means for acquiring frequency responses and coherences for the vibration signals;
a determination means for determining whether or not the coherences are greater than a predetermined threshold value; and
a rotation period calculation means for acquiring a frequency of and a phase difference of the vibration signals for the coherences, when determined to be greater than the threshold value, and calculating a rotation period of the rotating shaft from the frequency, the phase difference, the predetermined pitches, and the installation radii.

2. The rotation detection device according to claim 1, wherein the two or more accelerometers each detect gravity acceleration and output gravity signals,
the signal processing unit acquires the gravity signals, and
the installation information acquisition means acquires installation angles and the installation radii around the rotating shaft of the accelerometers, based on the gravity signals.

3. The rotation detection device according to claim 1, wherein the two or more accelerometers are installed with a separation angle of less than 180° around the rotating shaft.

4. The rotation detection device according to claim 1, wherein the two or more accelerometers are arranged serially, and
each of the predetermined pitches is retained by an interval member.

5. The rotation detection device according to claim 1, wherein the number of the accelerometers is three or more.

6. The rotation detection device according to claim 1, wherein the three or more accelerometers are each installed with an equal pitch around the rotating shaft.

7. The rotation detection device according to claim 1,
wherein the signal processing unit includes a signal generation means that generates a rotation reference signal, and
the rotation reference signal is generated in accordance with the rotation period of the rotating shaft.

8. The rotation detection device according to claim 7,
wherein the signal processing unit includes an output unit that outputs signals and/or data to the outside, and
the rotation reference signal is output from the output unit.

9. The rotation detection device according to claim 8, wherein the signal processing unit outputs the rotation reference signal from the output unit per rotation period of the rotating shaft.

10. A method for detecting rotation, comprising:
a step of installing accelerometers which detect rotation vibration of a rotary machine and output vibration signals, at predetermined pitches around a rotating shaft of the rotary machine;
a step of acquiring the vibration signals from the accelerometers;
a step of acquiring installation radii around the rotating shaft of the accelerometers;
a step of performing coherence analysis on the vibration signals to acquire coherences per frequency band;
a step of determining whether or not the coherences are greater than a predetermined threshold value;
a step of performing frequency response analysis on the vibration signals to acquire frequency responses;
a step of acquiring a frequency of the vibration signals;
acquiring a phase difference of the vibration signals; and
a step of acquiring a rotation period of the rotating shaft, based on the frequency, the phase difference, the installation radii, and the predetermined pitch.
